(19) United States
(12) Patent Application Publication
(10) Pub. No.: US 2016/0023878 A1
(43) Pub. Date: Jan. 28, 2016

(54) Funnel Device and System

(71) Applicant: Scott Stevenson, Prince George (CA)

(72) Inventor: Scott Stevenson, Prince George (CA)

(21) Appl. No.: 14/340,865

(22) Filed: Jul. 25, 2014

(51) Int. Cl. B67C 11/02

(52) U.S. Cl. CPC B67C 11/02

(57) ABSTRACT

A funnel device and system transfers liquid materials, such as oil, into a container. The device includes a bowl having a bottom wall and a perimeter wall coupled to and extending upwardly from the bottom wall defining an interior space of the bowl for receiving a fluid therein. A top edge of the perimeter wall defines an access opening into the interior space of the bowl. The bottom wall has a hole positioned therein between a top surface and a bottom surface of the bottom wall. A flange is coupled to and extends downwardly from the perimeter wall and has a bottom edge for engaging a lid of a container. A spout is coupled to the bottom wall at the hole. The spout has an open top end and an open bottom end wherein the spout directs the fluid outwardly from the interior space of the bowl into the container.

### BACKGROUND OF THE DISCLOSURE

1. Field of the Disclosure

The disclosure relates to funnel systems and more particularly pertains to a new funnel system for transferring liquid materials, such as oil, into a container.

2. Summary of the Disclosure

An embodiment of the disclosure meets the needs presented above by generally comprising a bowl having a bottom wall and a perimeter wall coupled to and extending upwardly from the bottom wall defining an interior space of the bowl for receiving a fluid therein. A top edge of the perimeter wall defines an access opening into the interior space of the bowl. The bottom wall has a hole positioned therein between a top surface and a bottom surface of the bottom wall. A flange is coupled to and extends downwardly from the perimeter wall and has a bottom edge for engaging a lid of a container. A spout is coupled to the bottom wall at the hole. The spout has an open top end and an open bottom end wherein the spout directs the fluid outwardly from the interior space of the bowl into the container.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a funnel device according to an embodiment of the disclosure.

FIG. 2 is a side view of an embodiment of the disclosure.

FIG. 3 is a top view of an embodiment of the disclosure.

FIG. 4 is a cross-sectional view of an embodiment of the disclosure taken along line 4-4 of FIG. 1.

FIG. 5 is a side view of a funnel system of an embodiment of the disclosure.

### DESCRIPTION OF THE PREFERRED EMBODIMENT

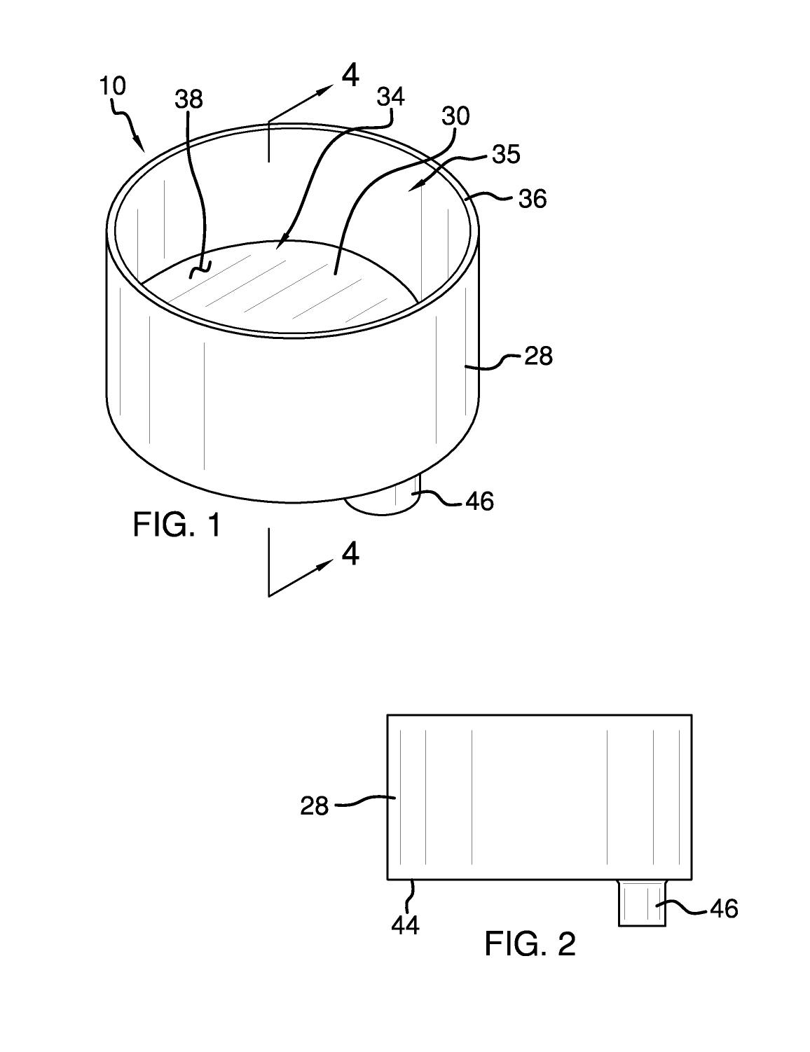

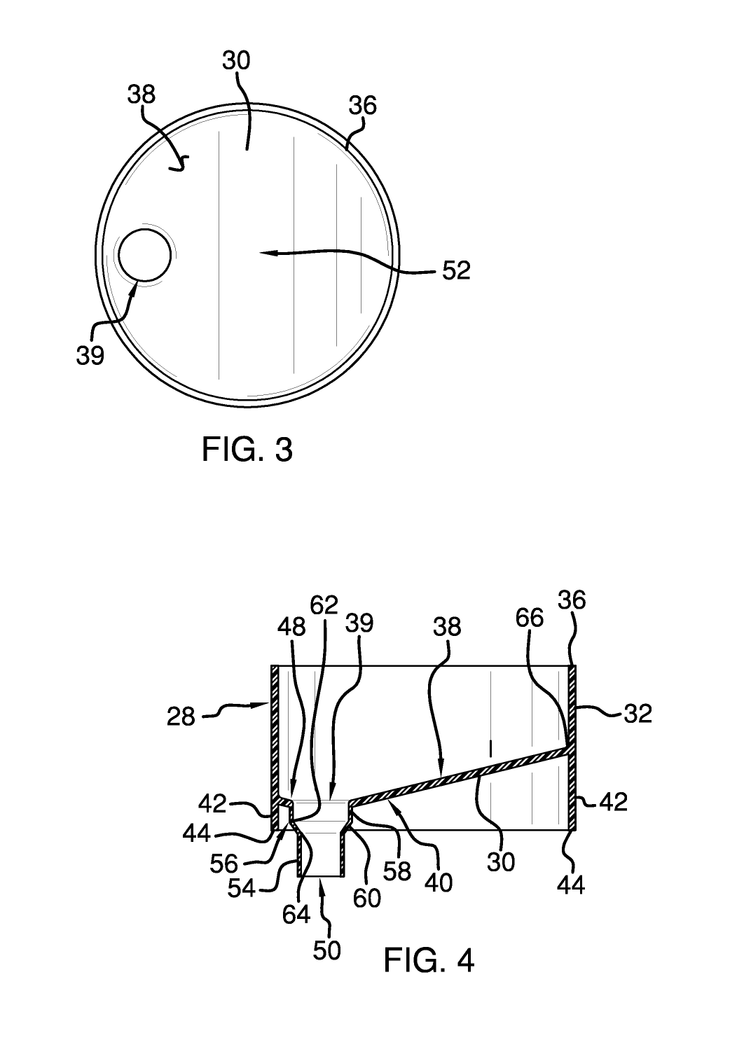

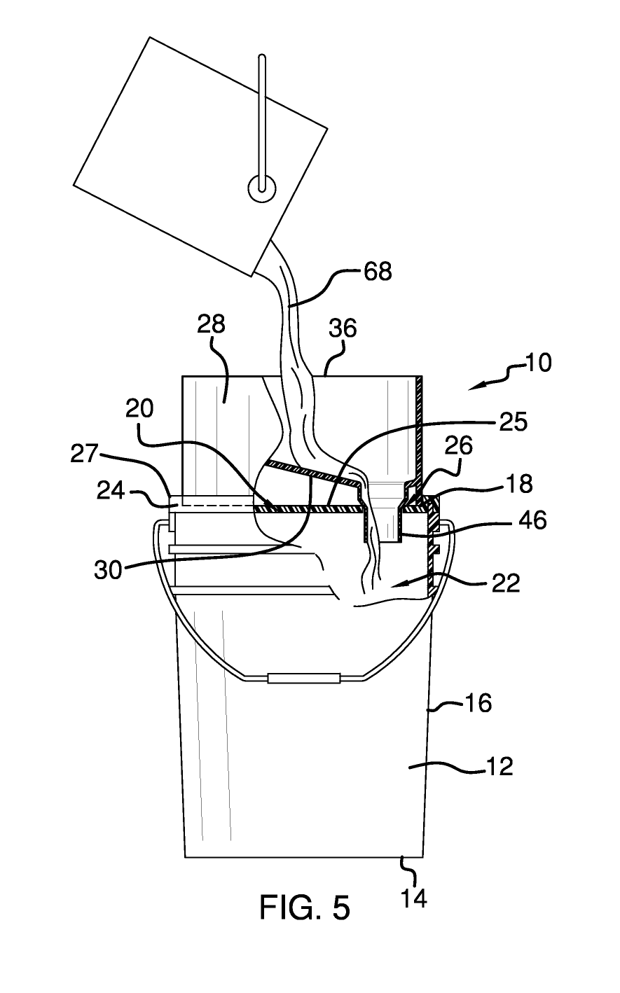

With reference now to the drawings, and in particular to FIGS. 1 through 5 thereof, a new funnel system embodying the principles and concepts of an embodiment of the disclosure and generally designated by the reference numeral 10 will be described.

As best illustrated in FIGS. 1 through 5, the funnel device and system 10 generally comprises a container 12 having a lower wall 14 and a peripheral wall 16 coupled to and extending upwardly from the lower wall 14. An upper edge 18 of the peripheral wall 16 defines an access opening 20 into an interior 22 of the container 12. The container 12 may comprise a 5-gallon bucket of conventional design. A lid 24 is positionable on the upper edge 18 to cover the access opening 20 into the interior 22 of the container 12. The lid 24 has a planar upper surface 25 and may have a lip 27 attached to and extending upwardly from the planar upper surface 25. The lip 27 defines a boundary extending around the planar upper surface 25. An aperture 26 is positioned in the planar upper surface 25.

A bowl 28 is provided having a bottom wall 30 and a perimeter wall 32 coupled to and extending upwardly from the bottom wall 30 defining an interior space 34 of the bowl 28 configured for receiving a fluid 68, such as oil or the like, therein. A top edge 36 of the perimeter wall 32 defines an access opening 35 into the interior space 34 of the bowl 28. The bottom wall 30 has a top surface 38 that may be planar. The bottom wall 30 has a hole 39 positioned therein between the top surface 38 and a bottom surface 40 of the bottom wall 30.

A flange 42 is coupled to and extends downwardly from the perimeter wall 32. The flange 42 has a bottom edge 44 that is engageable with the lid 24. The bottom edge 44 of the flange 42 is planar and horizontally orientated relative to the perimeter wall 32. The flange 42 may be coextensive with the perimeter wall 32.

A spout 46 is coupled to the bottom wall 30 at the hole 39. The spout 46 may be integrally coupled to the bottom wall 30. The spout 46 has an open top end 48 and an open bottom end 50. The open bottom end 50 is aligned with the aperture 26 wherein the spout 46 is configured for directing the fluid 68 outwardly from the interior space 34 of the bowl 28 into the container 12. More particularly, the open top end 48 of the spout 46 is coupled to the bottom wall 30 at the hole 39. The spout 46 may be positioned nearer to the perimeter wall 32 than to a center 52 of the bottom wall 30. The top surface 38 of the bottom wall 30 may slant downwardly from the perimeter wall 32 to the spout 46. The spout 46 and the bowl 28 are each constructed from a rigid material, such as plastic, metal or the like.

The spout 46 may include a lower section 54 extending below the bottom edge 44 of the flange 42. The lower section 54 extends transversely relative to the bottom edge 44 of the flange 42 and extends into the aperture 26. The spout 46 further includes an upper section 56 coupled to the lower section 54. The upper section 56 includes the open top end 48 of the spout 46. The upper section 56 extends between the hole 39 and the lower section 54 of the spout 46 and includes a straight portion 58 and a slanted portion 60 coupled together. The straight portion 58 is coupled to and extends downwardly from the open top end 48 of the spout 46. The slanted portion 60 tapers inwardly from a bottom 62 of the straight portion 58 to a top 64 of the lower section 54.

A height from the top edge 36 of the bowl 28 to the bottom edge 44 of the flange 42 may measure between approximately 13.0 cm and 18.0 cm. A diameter of the bottom wall 30 may measure between approximately 22.0 cm and 25.0 cm. A distance between the bottom edge 44 of the flange 42 to the hole 39 may measure between approximately 2.0 cm and 3.5 cm. A distance from the bottom edge 44 of the flange to an uppermost edge 66 may measure between approximately 5.5 cm and 8.0 cm. A diameter of the open top end 48 of the spout 46 may measure between approximately 3.5 cm and 7.5 cm. A diameter of the open bottom end 50 of the spout 46 may measure between approximately 2.0 cm and 3.0 cm.

In use, the bowl 28 is positioned on the lid 24 of the container 12 so that an entirety of the bottom edge 44 of the flange 42 engages the lid 24 to support the bowl 28 on the lid 24. The spout 46 is aligned with the aperture 26 in the lid 24 so that fluid 68 poured into the bowl 28 is directed into the container 12 through the spout 46. The fluid 68 may be oil or the like to allow for recycling of the fluid 68 into the container 12.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A funnel device comprising:
a bowl having a bottom wall and a perimeter wall coupled to and extending upwardly from said bottom wall defining an interior space of said bowl configured for receiving a fluid therein, a top edge of said perimeter wall defining an access opening into said interior space of said bowl, said bottom wall having a hole positioned therein between a top surface and a bottom surface of said bottom wall;
a flange coupled to and extending downwardly from said perimeter wall, said flange having a bottom edge configured for engaging a lid of a container; and
a spout coupled to said bottom wall at said hole, said spout having an open top end and an open bottom end wherein said spout is configured for directing the fluid outwardly from said interior space of said bowl into the container.

2. The device of claim 1, further comprising said bottom wall having a top surface being planar.

3. The device of claim 2, further comprising said top surface of said bottom wall slanting downwardly from said perimeter wall to said spout.

4. The device of claim 1, further comprising said flange extending straight down from said perimeter wall, said bottom edge of said flange being planar and horizontally orientated relative to said perimeter wall.

5. The device of claim 1, further comprising said flange being coextensive with said perimeter wall.

6. The device of claim 1, further comprising said open top end of said spout being coupled to said bottom wall at said hole.

7. The device of claim 1, further comprising said spout including a lower section extending below said bottom edge of said flange.

8. The device of claim 7, further comprising said lower section of said spout extending transversely relative to said bottom edge of said flange.

9. The device of claim 1, further comprising said spout being integrally coupled to said bottom wall.

10. The device of claim 7, further comprising said spout further including an upper section coupled to said lower section, said upper section including said open top end of said spout, said upper section extending between said hole and said lower section of said spout.

11. The device of claim 10, further comprising said upper section including a straight portion and a slanted portion coupled together, said straight portion being coupled to and extending downwardly from said open top end of said spout, said slanted portion tapering inwardly from a bottom of said upper section to a top of said lower section.

12. The device of claim 1, further comprising said spout being positioned nearer to said perimeter wall than to a center of said bottom wall.

13. A funnel device comprising:
a bowl having a bottom wall and a perimeter wall coupled to and extending upwardly from said bottom wall defining an interior space of said bowl configured for receiving a fluid therein, a top edge of said perimeter wall defining an access opening into said interior space of said bowl, said bottom wall having a top surface being planar, said bottom wall having a hole positioned therein between a top surface and a bottom surface of said bottom wall;
a flange coupled to and extending downwardly from said perimeter wall, said flange having a bottom edge configured for engaging a lid of a container, said flange extending straight down from said perimeter wall, said bottom edge of said flange being planar and horizontally orientated relative to said perimeter wall, said flange being coextensive with said perimeter wall; and
a spout coupled to said bottom wall at said hole, said spout having an open top end and an open bottom end wherein said spout is configured for directing the fluid outwardly from said interior space of said bowl into the container, said open top end of said spout being coupled to said bottom wall at said hole, said spout being positioned nearer to said perimeter wall than to a center of said bottom wall, said top surface of said bottom wall slanting downwardly from said perimeter wall to said spout, said spout including a lower section extending below said bottom edge of said flange, said lower section extending transversely relative to said bottom edge of said flange, said spout being integrally coupled to said bottom wall, said spout further including an upper section coupled to said lower section, said upper section including said open top end of said spout, said upper section extending between said hole and said lower section of said spout, said upper section including a straight portion and a slanted portion coupled together, said straight portion being coupled to and extending downwardly from said open top end of said spout, said slanted portion tapering inwardly from a bottom of said upper section to a top of said lower section.

14. A funnel system comprising:
a container having a lower wall and a peripheral wall coupled to and extending upwardly from said lower wall, an upper edge of said peripheral wall defining an access opening into an interior of said container;
a lid positionable on said upper edge to cover said access opening into said interior of said container, said lid having an aperture positioned therein;
a bowl having a bottom wall and a perimeter wall coupled to and extending upwardly from said bottom wall defining an interior space of said bowl configured for receiving a fluid therein, a top edge of said perimeter wall defining an access opening into said interior space of said bowl, said bottom wall having a hole positioned therein between a top surface and a bottom surface of said bottom wall;
a flange coupled to and extending downwardly from said perimeter wall, said flange having a bottom edge being engageable with said lid; and
a spout coupled to said bottom wall at said hole, said spout having an open top end and an open bottom end, said open bottom end being aligned with said aperture wherein said spout is configured for directing the fluid outwardly from said interior space of said bowl into said container.

15. The system of claim 14, further comprising:
said bottom wall having a top surface being planar;
said flange extending straight down from said perimeter wall, said bottom edge of said flange being planar and horizontally orientated relative to said perimeter wall, said flange being coextensive with said perimeter wall; and
said open top end of said spout being coupled to said bottom wall at said hole, said spout being positioned nearer to said perimeter wall than to a center of said bottom wall, said top surface of said bottom wall slanting downwardly from said perimeter wall to said spout, said spout including a lower section extending below said bottom edge of said flange, said lower section extending transversely relative to said bottom edge of said flange, said lower section extending into said aperture, said spout being integrally coupled to said bottom wall, said spout further including an upper section coupled to said lower section, said upper section including said open top end of said spout, said upper section extending between said hole and said lower section of said spout, said upper section including a straight portion and a slanted portion coupled together, said straight portion being coupled to and extending downwardly from said open top end of said spout, said slanted portion tapering inwardly from a bottom of said upper section to a top of said lower section.
